(19) United States
(12) Patent Application Publication
(10) Pub. No.: US 2025/0149224 A9
(43) Pub. Date: May 8, 2025

(54) WIRELESS POWER TRANSMISSION COIL

(71) Applicant: Hideo KIKUCHI, Tokyo (JP)

(72) Inventor: Hideo KIKUCHI, Tokyo (JP)

(21) Appl. No.: 18/261,399

(22) PCT Filed: Jan. 13, 2022
(86) PCT No.: PCT/JP2022/000807

§ 371 Date: Jul. 13, 2023

(30) Foreign Application Priority Data
Jan. 14, 2021 (JP) 2021-003969
Jun. 24, 2021 (JP) 2021-105261

(51) Int. Cl. H01F 17/00; H01F 27/28; H02J 50/10

(52) U.S. Cl. CPC H01F 17/0006; H01F 27/2828; H01F 2017/004; H02J 50/10

(57) ABSTRACT

A wireless power transmission coil comprising a first helical coil portion, a first spiral coil portion, a second helical coil portion, a second spiral coil portion, and a third helical coil portion which comprise windings with a common central axis. The inner end of the first spiral coil portion is connected to the upper end of the first helical coil portion. The upper end of the second helical coil portion is connected to the outer end of the first spiral coil portion. The inner end of the second spiral coil portion is connected to the lower end of the first helical coil portion. The lower end of the third helical coil portion is connected to the outer end of the second spiral coil portion. In this way, imbalance in winding currents of the coil is eliminated to reduce alternating-current resistance of the coil.

### FIELD OF THE INVENTION

The present invention relates to a wireless power transmission coil used in a wireless power transmission system in which the electric power is transmitted from a power supply circuit to a load over a space.

### BACKGROUND OF THE INVENTION

A wireless power transmission system, which does not use a power cable or a power transmission cable, has been proposed as disclosed in Patent Document 1. In the wireless power transmission system, power is transmitted wirelessly from the power transmitting coil in the power transmitter to the power receiving coil in the power receiver by resonating an alternating current (AC) magnetic field of the power transmitting coil on the transmitter side and an AC magnetic field of the power receiving coil of the resonant circuit on the receiver side.

When wireless power is transmitted by widening the distance between the power transmitting coil on the power transmitter side and the power receiving coil on the power receiver side, the loss at the power transmitting coil and the power receiving coil must be minimized in order to increase the wireless power transmission efficiency. Therefore, it is necessary to reduce the AC resistance of the power transmitting coil and the power receiving coil.

When spiral coils, in which a conductor pattern is spirally wound flat, are used as the power transmitting coil and the power receiving coil, there is a portion where the current density is higher in the inner windings of the spiral coil. Which causes the problem of increasing the AC resistance of the coil due to the large non-uniformity of the current density flowing through the windings. For a solution to this problem, Patent Document 2 proposes the following coil. That is, the innermost winding of the spiral coil is divided into strip conductors, the windings of the strip conductors are exchanged, and the windings of the strip conductors are meandered so that the windings of the strip conductor are alternately arranged on the innermost circumference to average out the non-uniformity of the current within the windings. As a result, non-uniformity in the density of the current flowing through the windings of the coil is reduced, the influence of the proximity effect is suppressed, and the AC resistance of the coil is reduced.

### PRIOR ART LITERATURE

### Patent Literature

Patent Document 1: Japanese Patent Application Laid-Open Publication No. 2009-106136
Patent Document 2: International Publication No. WO2012/039045

### SUMMARY OF THE INVENTION

### Problem to be Solved by the Invention

When helical coils are used as the power transmitting coil and the power receiving coil, there are the following problems. FIG. 7 is a schematic perspective view of a conventional helical coil. FIG. 8 is a sectional view of the coil along a plane containing the central axis 1 of the helical coil. In the technique of Patent Document 2, the distance between the winding position at the center of the helical coil and the winding positions at the upper and lower ends of the coil is large. Thus, it is difficult to make the winding meander between the winding positions to reduce the non-uniformity of the current in the windings of the coil.

As described above, when a helical coil is used, there is the problem that the AC resistance cannot be reduced because the non-uniformity in the density of the current flowing through the windings cannot be eliminated by the meandering of the windings of the coil.

Therefore, the problem of the present invention is to reduce the current non-uniformity in the windings of a helical coil to reduce the AC resistance of the coil.

### Means for Solving the Problem

In order to solve the problem, an aspect in accordance with the present invention is a wireless power transmission coil comprising: a first helical coil portion, a first spiral coil portion, a second helical coil portion, a second spiral coil portion, and a third helical coil portion, wherein the first helical coil portion, the first spiral coil portion, the second helical coil portion, the second spiral coil portion, and the third helical coil portion have windings that share a central axis, wherein an inner end of the first spiral coil portion is connected to an upper end of the first helical coil portion, an upper end of the second helical coil portion is connected to an outer end of the first spiral coil portion, an inner end of the second spiral coil portion is connected to an lower end of the first helical coil portion, and an lower end of the third helical coil portion is connected to an outer end of the second spiral coil portion.

With this configuration, the present invention has the effect of eliminating non-uniformity of the current density in the windings of the coil and reducing the AC resistance of the coil.

An aspect in accordance with the present invention is a wireless power transmission coil, a doughnut-shaped cylindrical space surrounding an central axis of the coil, an surface of the doughnut-shaped cylindrical space being covered with multi-turn winding wires wound around the central axis, an area of the surface of the cylindrical space being divided into an even number of annular regions which have a predetermined width and make one turn around the central axis of the coil, each annular region being covered with series of the multi-turn winding wires around the central axis, and wherein a first annular region is covered with an first series of the multi-turn winding wires and a second annular region is covered with a second series of the multi-turn wining wires, and an end of the first series of the multi-turn winding wires and an adjacent end of the second series of the multi-turn winding wires are electrically connected in parallel to a same terminal of the coil, and wherein the first series of the multi-turn winding wires and the second series of the multi-turn winding wires are wired in parallel in a same direction from the same terminal of the coil, whereby the series of multi-turn winding wires of each of the annular region are connected in parallel between the terminals of the coil, and the ends of the series of the multi-turn winding wires connecting to a different terminal of the coil are spaced apart by at least the width of the annular region.

An aspect in accordance with the present invention is a wireless power transmission coil according to claim 2, a doughnut-shaped cylindrical space surrounding an central axis of the coil, an surface of the donut-shaped cylindrical space being covered with a series of multi-turn winding wires wound around the central axis of the coil, an area of the surface of the cylindrical space being divided into a first annular region and a second annular region which have a predetermined width and making one turn around the central axis of the coil, each annular region being covered with series of the multi-turn winding wires around the central axis, wherein the first annular region is covered with first series of multi-turn winding wires and the second annular region is covered with second series of multi-turn winding wires, and an end of the first series of the multi-turn winding wires and an adjacent end of the second series of the multi-turn winding wires are electrically connected in parallel to a same terminal of the coil, and wherein the first series of the multi-turn winding wires and the second series of the multi-turn winding wires are wired in a same direction in parallel from the same terminal of the oil, whereby the series of multi-turn winding wires of each of the annular region are connected in parallel between the first terminal and the second terminal of the coil, and the end of the series of the multi-turn winding wires connecting the first terminal and the end of the series of the multi-turn winding wires connecting the second terminal are spaced apart by at least the width of the annular region.

### Effects of the Invention

A wireless power transmission coil of the present invention has a first helical coil portion, a first spiral coil portion, a second helical coil portion, a second spiral coil portion, and a third helical coil portion, having windings sharing a central axis. The inner end of the first spiral coil portion is connected to the upper end of the first helical coil portion. The upper end of the second helical coil portion is connected to the outer end of the first spiral coil portion. The inner end of the second spiral coil portion is connected to the lower end of the first helical coil portion. The lower end of the third helical coil portion is connected to the outer end of the second spiral coil portion.

With this configuration, the present invention has the effect of eliminating non-uniformity of the current density in the windings of the coil and reducing the AC resistance of the coil.

### BRIEF DESCRIPTION OF THE DRAWINGS

FIG. 1 is a cross-sectional view of a wireless power transmission coil according to a first embodiment of the present invention.

FIG. 2 is a plan view of the wireless power transmission coil according to a first embodiment of the present invention.

FIG. 3 is a cross-sectional view of a coil representing an external magnetic field applied to the windings of the coil for wireless power transmission by the proximity effect according to the first embodiment of the present invention.

FIG. 4 is a graph of first simulation results of the AC resistances of the wireless power transmission coil of the first embodiment of the present invention and the conventional helical coil.

FIG. 5 is a cross-sectional view of a simulation model of the wireless power transmission coil according to the first embodiment of the present invention, showing dimensions of the coil.

FIG. 6 is a plan view of the simulation model of the wireless power transmission coil according to the first embodiment of the present invention.

FIG. 7 is a schematic perspective view of a conventional helical coil simulation model.

FIG. 8 is a cross-sectional view of the conventional helical coil simulation model.

FIG. 9 is a graph of second simulation results of the AC resistances of the wireless power transmission coil of the first embodiment of the present invention and the conventional helical coil.

FIG. 10 is a cross-sectional view of a wireless power transmission coil according to a second embodiment of the present invention.

FIG. 11 is a perspective view of a portion of a doughnut-shaped cylindrical space portion of the wireless power transmission coil according to the second embodiment of the present invention.

FIG. 12 is a cross-sectional view of a wireless power transmission coil according to a fourth embodiment of the present invention.

FIG. 13 is a perspective view of a portion of a doughnut-shaped cylindrical space portion of the wireless power transmission coil according to the fourth embodiment of the present invention.

### DETAILED DESCRIPTION OF THE INVENTION

### First Embodiment

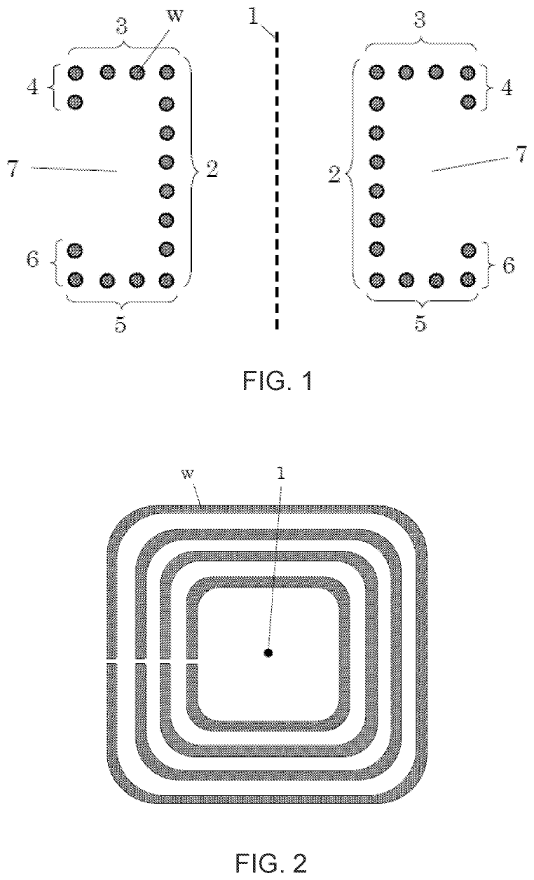

The embodiments are described with reference to FIG. 1 to FIG. 8. FIG. 1 is a cross-sectional view of a coil for wireless power transmission according to the first embodiment taken along a plane including a central axis 1 of the coil. FIG. 2 is a plan view of the coil. The wireless power transmission coil of this embodiment includes the first helical coil portion 2, the first spiral coil portion 3, the second helical coil portion 4, and the second spiral coil portion 5, and the third helical coil portion 6. These portions 2-5 have windings w that share the central axis 1. As shown in the plan view of FIG. 2, the windings w are connected in series. The rear end of the front winding w connected to the front end of the rear winding w.

The first spiral coil portion 3 is arranged on a first horizontal plane which is a plane perpendicular to the central axis 1 of the coil. The second spiral coil portion 5 is arranged on a second horizontal plane parallel to the first horizontal plane. The inner end of the first spiral coil portion 3 is connected to the upper end of the first helical coil portion 2. The outer end of the first spiral coil portion 3 is connected to the upper end of the second helical coil portion 4. A first terminal of the coil is provided at the lower end of the second helical coil portion 4.

The inner end of the second spiral coil portion 5 is connected to the lower end of the first helical coil portion 2. The lower end of the third helical coil portion 6 is connected to the outer end of the second spiral coil portion 5. A second terminal of the coil is provided at the upper end of the third helical coil portion 6.

Thus, the coil is made up of a series of windings w from the first terminal to the second terminal. The first terminal of the coil is connected to the lower end of the winding of second helical coil portion 4 and the coil winding w is wound from the lower end to the upper end of the second helical coil portion 4. Next, the coil winding w is wound from the outer end to the inner end of the first spiral coil portion 3. Next, the coil winding w is wound from the upper end to the lower end of the first helical coil portion 2. Next, the coil winding w is wound from the inner end to the outer end of the second spiral coil portion 5. Next, the coil winding w is wound from the lower end to the upper end of the third helical coil portion 6 and leads to the second terminal of the coil. Thereby, a coil having a shape in which most of the surface of the donut-shaped cylindrical space 7 is covered with winding wires w is formed.

### (First Simulation Model)

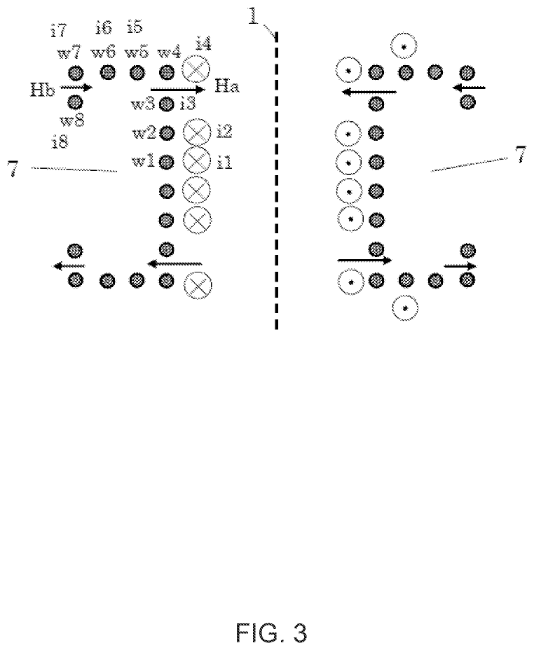

The mechanisms by which the AC resistance of the wireless power transmission coil is generated will be described with reference to FIG. 3. In the first simulation model, the coil for wireless power transmission consists of 16 parallel one-turn windings. The top half of the coil consists of eight one-turn windings, w1, w2, w3, w4, w5, w6, w7, w8 from the center of the coil to the ends of the coil. The same voltage is applied to these parallel windings and current flows. The current flowing through the winding w1 is i1, the current flowing through the winding w2 is i2, the current flowing through the winding w3 is i3, and the current flowing through the winding w8 is i8.

As shown in FIG. 3, in each of the windings w1 to w4 of the first helical coil portion 2, in addition to the magnetic field generated by the current flowing in each winding itself, an external magnetic field Ha is applied by the current flowing in the windings other than each winding itself. The intensity of the external magnetic field Ha is stronger at the position of the winding w4 than at the position of the winding w1. The induction of this external magnetic field Ha causes non-uniformity of the current density in the winding w.

That is, the current is reversed on the lower side of the windings w1, w2 and w3 and the forward current is strengthened on the upper side, causing non-uniformity of the current density on the surface of the winding w. Thus, non-uniformity of the current density in each winding w increases the AC resistance of each winding w. The AC resistance of the winding w3 is greater than that of the winding w1.

In the second helical coil portion 4, an external magnetic field Hb is applied to the windings w7 and w8. Due to the induction of this external magnetic field Hb, the current is reversed on the lower side of the winding w8, and the forward current is strengthened on the upper side.

On the other hand, since the external magnetic field applied to the lower side of the winding w8 is weaker than the external magnetic field applied to the upper side of the winding w8, the effect of the reverse current flow on the lower side of the winding w8 is reduced. As a result, the current non-uniformity in the winding w8 is reduced. Therefore, it has the effect of reducing the increase in the AC resistance of the winding w8 at the ends of the coil.

### (AC Resistance of the Coil in the First Simulation Result)

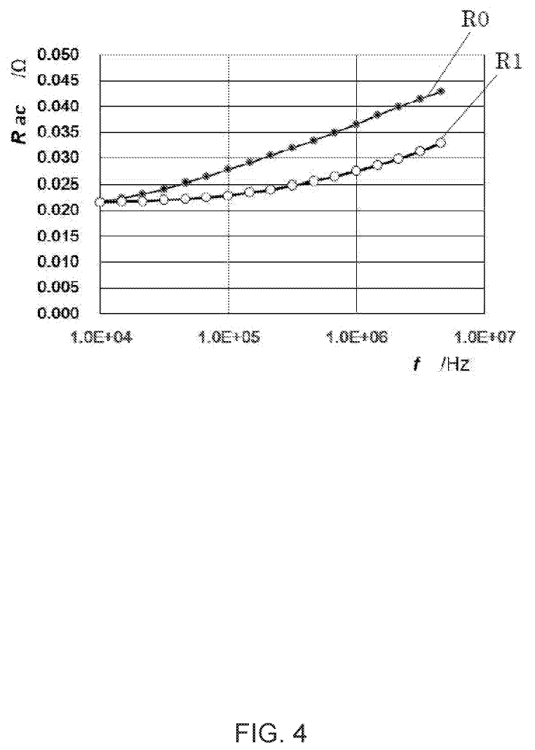

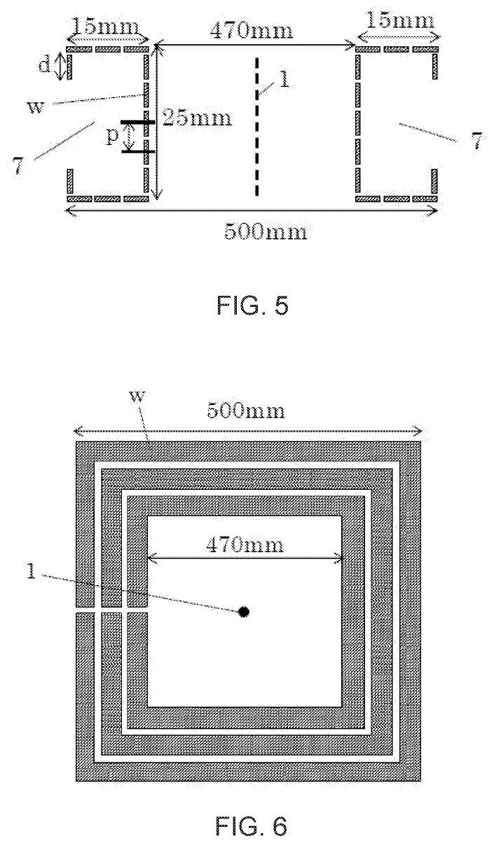

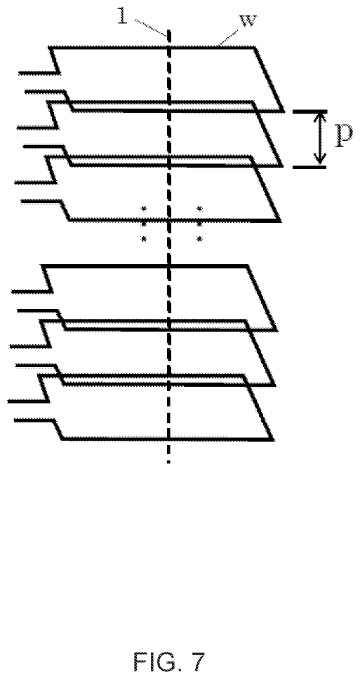

FIG. 4 shows a graph of a first simulation result of the coil for wireless power transmission according to this embodiment. It is a graph of the frequency characteristic of the AC resistance R1 of the coil for wireless power transmission shown in FIG. 5. The vertical axis of the graph indicates the AC resistance Rac of the coil. For comparison, FIG. 4 also shows a graph of the frequency characteristics of the simulation results of the AC resistance R0 of the conventional helical coil simulation model shown in FIG. 7.

FIG. 5 shows a cross-sectional view of the wireless power transmission coil for this simulation according to this embodiment, and FIG. 6 shows a plane view. Each winding w of the coil is a strip conductor of copper with a width d of 4.8 mm. The thickness of the winding w is set to 35 μm, which is thinner than the skin thickness of the skin effect at 5 MHz or less. Each winding is arranged in parallel with a pitch p of 5 mm.

The first helical coil portion 2 is a 5-turn coil with an inner diameter of 470 mm and a height of 25 mm. The first spiral coil portion 3 and the second spiral coil portion 5 are three-turn coils with an inner diameter of 470 mm and an outer diameter of 500 mm. The second helical coil portion 4 and the third helical coil portion 6 are single-turn coils with an outer diameter of 500 mm.

The reason why the thickness of the winding wire w is set to 35 μm is to exclude the influence of the skin thickness due to the skin effect on the AC resistance of the coil. For the wireless power transmission coil of the present embodiment, it is desirable to use a winding wire w having a thickness equal to or greater than the thickness of the skin thickness due to the skin effect.

In this wireless power transmission coil, coil windings w are sequentially wound from the lower side of the second helical coil portion 4 toward the upper side. Next, a coil windings w are sequentially wound from the outside to the inside of the first spiral coil portion 3. Next, coil windings w are sequentially wound from the upper side to the lower side of the first helical coil portion 2. Next, the coil windings w are sequentially wound from the inside to the outside of the second spiral coil portion 5. Next, coil windings w are sequentially wound from the lower side to the upper side of the third helical coil portion 6. In the first simulation, the AC resistance of a coil with these windings w connected in parallel was calculated.

### (Conventional Helical Coil)

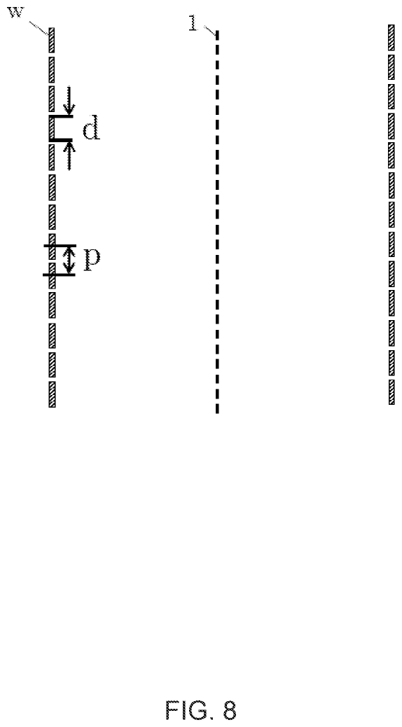

FIG. 7 shows a perspective view of a conventional helical coil simulation model, and FIG. 8 shows a sectional view of the model. As shown in the perspective view of FIG. 7, this helical coil is a helical coil in which windings w sharing a central axis 1 of the coil are sequentially wound from bottom to top.

In this helical coil, as shown in the cross-sectional view of FIG. 8, each winding w is a strip conductor of copper with a width d of 4.8 mm and a thickness of 35 μm. The helical coil is a coil with an inner diameter of 470 mm and a height of 65 mm. For this conventional helical coil, the AC resistance of the coil was calculated by performing a first simulation on a model in which each winding w for each turn was connected in parallel.

For comparison, FIG. 4 shows a graph of the frequency characteristics of the first simulation results of the AC resistance R0 of the conventional helical coil simulation model. As shown in FIG. 4, in the wireless power transmission coil of this embodiment, the increase in AC resistance R1 of the coil with increasing frequency is suppressed to less than half that of the conventional helical coil. The coil for wireless power transmission of this embodiment has the effect of reducing the AC resistance more than the helical coil.

### (Second Simulation)

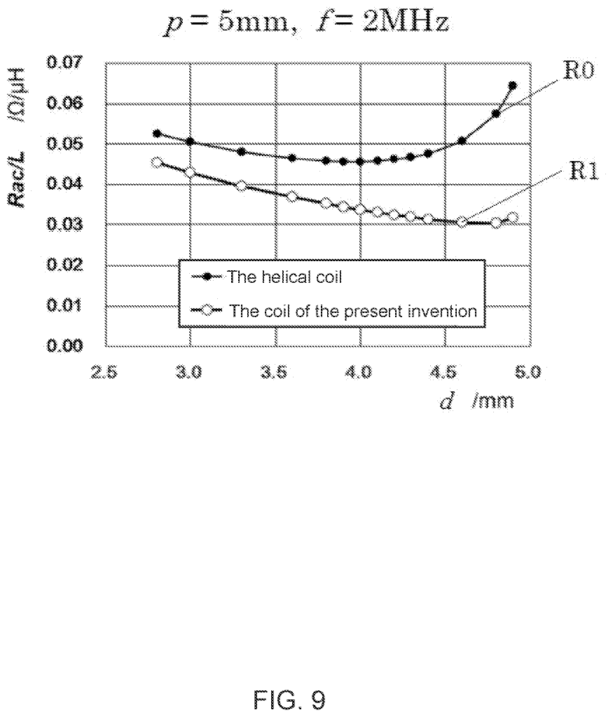

The coil model for the second simulation was a coil model in which each winding w was connected in series to form a single multi-turn coil. The AC resistance of the coil was calculated in a second simulation. FIG. 9 shows graphs of the second simulation results. First, in the wireless power transmission coil of this embodiment shown in FIG. 5, the AC resistance R1 of the coil in which each winding w of the wireless power transmission coil is connected in series is shown. Next, in the wireless power transmission coil of the conventional helical coil in FIG. 7, the AC resistance R0 of the coil in which each winding w of the wireless power transmission coil is connected in series is shown.

In FIG. 9, the frequency f is fixed at 2 MHz. Next, the pitch p of the coil windings is fixed at 5 mm. FIG. 9 shows a graph in which the width d of the windings w of several coils with different widths d of the windings w is plotted on the horizontal axis and the value of the AC resistance of each coil is plotted on the vertical axis. The vertical axis of the graph in FIG. 9 represents the AC resistance of the coil divided by the inductance of the coil, which is proportional to the AC resistance of the coil.

FIG. 9 compares the graph of the simulation result of the AC resistance R1 of the coil of this embodiment with the graph of the simulation result of the AC resistance R0 of the conventional helical coil. Regardless of the value of the winding width d of the coil, the AC resistance R1 of the wireless power transmission coil of this embodiment is smaller than the AC resistance R0 of the conventional helical coil. In the graph of the conventional helical coil, when the widths d of the windings w is close to the pitch p of the windings, the AC resistance R0 rather increases, and the proximity effect of the coil appears in the graph. On the other hand, in the graph of the wireless power transmission coil of the present embodiment, even if the width d of the winding wire w is close to the pitch p of the winding, the AC resistance R1 does not increase, and the proximity effect of the coil does not appear in the graph. This means that the AC resistance of each winding w of the wireless power transmission coil of this embodiment has little difference between each winding w of the coil.

From these, it is considered that the difference in the magnitude of the external magnetic field applied to the winding wire w for each winding w is reduced in the wireless power transmission coil of the present embodiment. The wireless power transmission coil of the present embodiment has the doughnut-shaped cylindrical space 7 surrounding the central axis of the coil. The surface of the doughnut-shaped cylindrical space 7 is covered with winding wires w of the first helical coil portion 2, the first spiral coil portion 3, the second helical coil portion 4, the second spiral coil portion 5, and the third helical coil portion 6. It is assumed that the magnetic field in the doughnut-shaped cylindrical space 7 covered with winding wires is weakened by them. Thus, the wireless power transmission coil of this embodiment has the effect of reducing the AC resistance more than the helical coil.

Thus, the wireless power transmission coil that has coil windings w sequentially wound from the lower side of the second helical coil portion 4 toward the upper side, coil windings w sequentially wound from the outside to the inside of the first spiral coil portion 3, coil windings w sequentially wound from the upper side to the lower side of the first helical coil portion 2, coil windings w sequentially wound from the inside to the outside of the second spiral coil portion 5, coil windings w sequentially wound from the lower side to the upper side of the third helical coil portion 6. This coil has the effect of suppressing an increase in the AC resistance of the coil with frequency.

Furthermore, the wireless power transmission coil of the first embodiment can reduce the height of the conventional helical coil from 65 mm to 25 mm. This has the effect of reducing the size of the structure in which the coil is installed.

### Second Embodiment

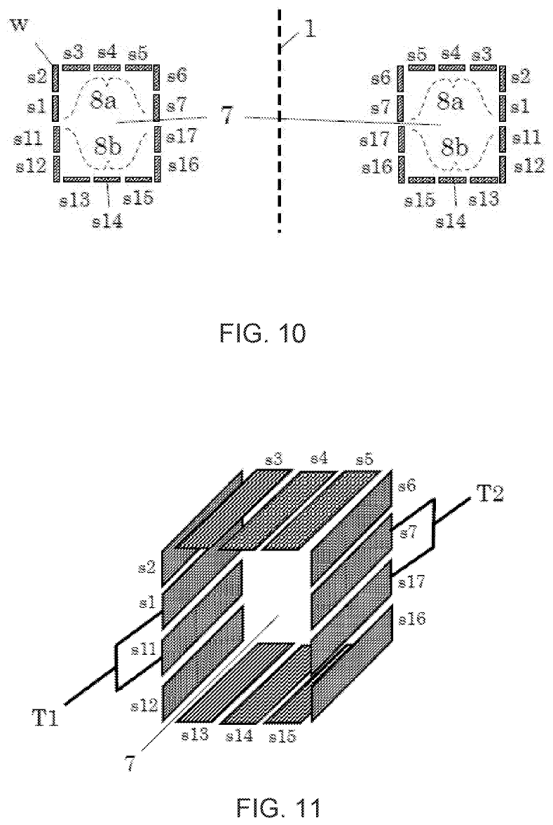

FIG. 10 shows a cross-sectional view of the wireless power transmission coil according to the second embodiment taken along a plane including the central axis 1 of the coil. FIG. 11 shows a perspective view of part of the doughnut-shaped cylindrical space 7 of the coil. The difference between the second embodiment and the first embodiment is that the coil windings w are divided into two groups in the second embodiment, and two multi-winding wires are provided in which the coil windings w are connected in series. Then, the surface of the doughnut-shaped cylindrical space 7 surrounding the central axis 1 of the coil is divided into two annular regions 8a and 8b, and each of the annular regions 8a and 8b is covered with a group of multi-turn winding wires.

FIG. 11 is a perspective view showing a portion of the doughnut-shaped cylindrical space 7 covered with winding wires w. As shown in FIG. 11, the surface of a doughnut-shaped cylindrical space 7 surrounding the central axis 1 of the coil is divided into an upper annular region 8a and a lower annular region 8b. Then, a first group of multi-turn winding wires in which s1 to s7 are connected in series covers the annular region 8a on the upper surface of the doughnut-shaped cylindrical space 7. And a second group of multi-turn winding wires in which s11 to s17 are connected in series covers the annular region 8b on the lower surface of the doughnut-shaped cylindrical space 7.

The first terminal T1 of the coil is electrically connected to the end of the winding wire s1 of the first group of multi-turn winding wires covering the annular region 8a, which is on the farthest side from the central axis 1 of the coil. And the end of the winding wire s11 parallel to the winding wire s1 is electrically connected to the first terminal T1 and in the same direction as s1. The winding wire s11 is furthest from the central axis 1 of the coil and belongs to the second group of multi-turn winding wires that covers the annular region 8b. Then, the winding wires s1 and s11 are connected in parallel in the same direction to the first terminal T1 of the coil.

Similarly, the second terminal T2 of the coil is electrically connected to the end of the winding wire s7 of the first group of multi-turn winding wires covering the annular region 8a, which is on the side closest to the central axis 1 of the coil. And the end of the winding wire s17 parallel to the winding wire s7 is electrically connected to the second terminal T2 and in the same direction as s7. The winding wire s17 is on the side closest to the central axis 1 of the coil and belongs to the second group of multi-turn winding wires that covers the annular region 8b. Then, the winding wires s7 and s17 are connected in parallel in the same direction to the second terminal T2 of the coil.

In this way, the first series of multi-turn winding wires and the second series of multi-turn winding wires are electrically connected in parallel to the first terminal T1 and the second terminal T2 of the coil. Then, the first series of seven-turn winding wires covers the annular region 8a, the second series of seven-turn winding wires covers the annular region 8b, and the entire surface of the doughnut-shaped cylindrical space 7 is covered with the winding wires w.

As a result of simulating the AC resistance of the coil of the second embodiment of this structure, the AC resistance of the coil was reduced as in the first embodiment. In the wireless power transmission coil of the present embodiment, the magnetic field in the doughnut-shaped cylindrical space 7 surrounded by the first series of seven-turn winding wires and the second series of seven-turn winding wires is weakened. As a result, the wireless power transmission coil according to the present embodiment has the effect of reducing the AC resistance more than the helical coil.

In this embodiment, the windings s1 and s11 electrically connected to the first terminal T1 of the coil and the windings s7 and s17 electrically connected to the second terminal T2 of the coil are not adjacent and separated. An insulating material of the coil insulates the winding wire w connected to the first terminal T1 and the winding wire w connected to the second terminal T2. Since the first terminal T1 and the second terminal T2 are separated, it is possible to reduce the influence of the dielectric loss of the insulating material of the coil, which causes the AC resistance of the coil.

### Third Embodiment

In the third embodiment, similarly to the second embodiment, the surface of a doughnut-shaped cylindrical space 7 surrounding the central axis 1 of the coil is covered by the multi-turn winding wires w around the central axis 1 of the coil. The difference between the third embodiment and the second embodiment is as follows. In the second embodiment, the surface of the doughnut-shaped cylindrical space 7 is divided into two annular regions, each of which is covered with multi-turn winding wires. In the third embodiment, the surface of the doughnut-shaped cylindrical space 7 is divided into four or more annular regions, and each region is covered with multi-turn winding wires.

That is, in the third embodiment, surface area of the donut-shaped cylindrical space 7 is divided into even number of annular regions. They are parallel to the central axis 1 of the coil and have a predetermined width. Then, for each annular region, the annular region is covered with a series of multi-turn winding wires w parallel to the annular region around the central axis 1 of the coil. One end of the series of multi-turn winding wires in each annular region is connected to the first terminal T1 of the coil and the other end of the series of multi-turn winding wires is connected to the second terminal T2 of the coil.

A first end of a second series of multi-turn winding wires on the second annular region is provided adjacent a first end of the first series of multi-turn winding wires on the first annular region. The first end of the first series of multi-turn winding wires on a first annular region and the first end of a second series of multi-turn winding wires are connected in parallel in the same direction to the first terminal T1 of the coil.

A second end of the third series of multi-turn winding wires on the third annular region is provided adjacent a second end of the first series of multi-turn winding wires on the first annular region. The second end of the first series of multi-turn winding wires on a first annular region and the second end of the third series of multi-turn winding wires are connected in parallel in the same direction to the second terminal T2 of the coil.

Similarly, a first end of the fourth series of multi-turn winding wires on the fourth annular region is provided adjacent a first end of the third series of multi-turn winding wires on the third annular region. The first end of the third series of multi-turn winding wires on the third annular region and the first end of the fourth series of multi-turn winding wires are connected in parallel in the same direction to the first terminal T1 of the coil. The first end of the third series of multi-turn winding wires on a third annular region and the first end of the fourth series of multi-turn winding wires are connected in parallel in the same direction to the first terminal T1 of the coil. The second end of the fourth series of multi-turn winding wires are connected to the second terminal T2 of the coil.

In this way, an even number of series of multi-turn winding wires such as the first series of multi-turn winding wires, the second series of multi-turn winding wires, the third series of multi-turn winding wires, and the fourth series of multi-turn winding wires are electrically connected in parallel to the first terminal T1 and the second terminal T2 of the coil. The first ends of these series of multi-turn winding wires connected to the first terminal T1 of the coil and the second ends of these series of multi-turn winding wires connected to the second terminal T2 of the coil are spaced apart by the width of the annular region.

Since the first ends of them connected the first terminal T1 and the second ends of them connected the second terminal T2 are spaced apart, it is possible to reduce the influence of the dielectric loss of the insulating material of the coil, which causes the AC resistance of the coil.

In addition, this embodiment has the effect of reducing the number of turns of the series of the multi-turn winding wires to a number divided by the number of the series of the multi-turn winding wires, which is the number of the annular regions. That is the number of turns of the coil. Reducing the number of turns of the coil in this way has the effect of reducing the inductance of the coil.

### Fourth Embodiment

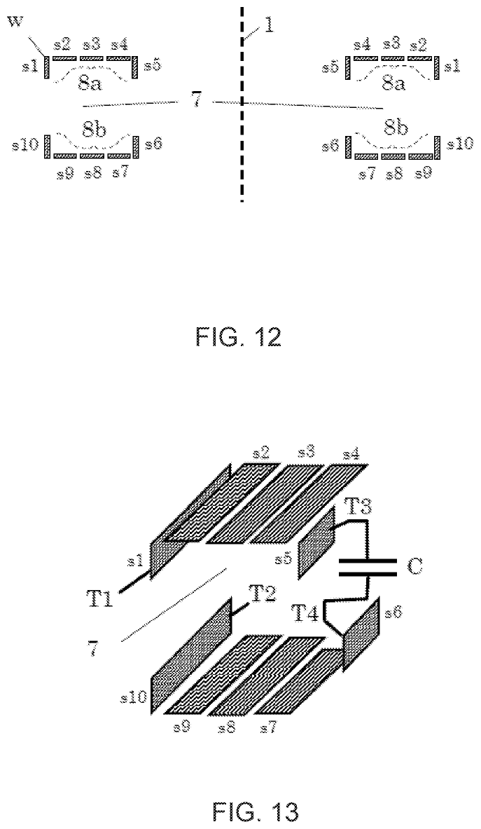

FIG. 12 shows a cross-sectional view of the wireless power transmission coil of the fourth embodiment taken along a plane including the central axis 1 of the coil. FIG. 13 shows a perspective view of part of the doughnut-shaped tubular space 7 of the coil. As in the second embodiment, the coil windings w are divided into two groups, a first group of series of multi-turn winding wires in which the windings s1 to s5 cover the first annular region 8a on the upper surface of the doughnut-shaped cylindrical space 7, and a second group of series of multi-turn winding wires in which the windings s6 to s10 cover the second annular region 8a on the lower surface of the doughnut-shaped cylindrical space 7.

The difference between the fourth embodiment and the second embodiment is as follows. The end of the winding wire s5 at the second end of the first group of series of multi-turn winding wires is connected to the third terminal T3, and the end of the winding wire s6 at the first end of the second group of series of multi-turn winding wires is connected to the fourth terminal T4. The third terminal T3 and the fourth terminal T4 are connected to the terminals of the resonance capacitor C for wireless power transmission. Then, the first group of multi-turn winding wires, the resonance capacitor C, and the second group of multi-turn winding wires are connected in series and wiring in the same direction. And there is a gap between windings s5 and s6. Therefore, the end winding s5 of the first group of multi-turn windings connected to the third terminal T3 is not adjacent to the end winding s6 of the second group of multi-turn windings connected to the fourth terminal T4.

The end of the winding wire s1 at the first end of the first group of series of multi-turn winding wires is connected to the first terminal T1, and the end of the winding wire s10 at the second end of the second group of series of multi-turn winding wires is connected to the second terminal T2. The first terminal T1 and the second terminal T2 are connected to the terminals of the AC power supply for the wireless power transmission system.

In the case shown in FIGS. 12 and 13 there is a gap between winding wires s1 and s10. The winding wire s1 is at the end of the first group of multi-turn winding wires connecting the first terminal T1 of the coil. The winding wire s10 is at the end of the second group of multi-turn winding wires connecting the second terminal T2 of the coil. Winding wire s1 and winding wire s10 may have close gaps between their terminals. The reason for this is that the amplitude of the voltage applied between the first terminal T1 and the second terminal T2 of the coil to which the terminals of the AC power supply for wireless power transmission are connected is relatively small.

On the other hand, the amplitude of the voltage applied between the third terminal T3 and the fourth terminal T4 of the coil to which the terminals of the resonance capacitor C are connected is high. Therefore, a gap is required to separate the winding wire s5 at the end of the first group of multi-turn winding wires and the winding wire s6 at the end of the second group of multiple winding wires.

### INDUSTRIAL APPLICABILITY

The coil for wireless power transmission according to the present invention is applicable for non-contact power feeding to moving objects such as electric vehicles and aircraft, and for supplying electric power to an electronic device installed on a desk across a desk plate. Also, it can be applied to supply electric power to in vivo electronic devices buried in the human body through skin without power lines.

### REFERENCE NUMERALS

1 Central axis of the coil
2 First helical coil portion
3 First spiral coil portion
4 Second helical coil portion
5 Second spiral coil portion
6 Third helical coil portion
7 Doughnut-shaped cylindrical space
8a First annular region
8b Second annular region
C Resonance capacitor
D Width of the winding wire
F Frequency of AC power applied to the coil
Ha, Hb External magnetic field applied to the winding wire
i1, i2, i3, i4, i5, i6, i7, i8 Current on the winding wire
p Pitch of the winding
R0 AC resistance of the conventional helical coil
R1 AC resistance of the coil for wireless power transmission according to the present invention
Rac AC resistance of the coil
s1, s2, s3, s4, s5, s6, s7, s11, s12, s13, s14, s15, s16, s17 Winding wire
T1 First terminal
T2 Second terminal
T3 Third terminal
T4 Fourth terminal
w, w1, w2, w3, w4, w5, w6, w7, w8 Winding wire

What is claimed is:

1. A wireless power transmission coil comprising: a first helical coil portion, a first spiral coil portion, a second helical coil portion, a second spiral coil portion, and a third helical coil portion, wherein the first helical coil portion, the first spiral coil portion, the second helical coil portion, the second spiral coil portion, and the third helical coil portion have windings that share a central axis,
wherein an inner end of the first spiral coil portion is connected to an upper end of the first helical coil portion, an upper end of the second helical coil portion is connected to an outer end of the first spiral coil portion, an inner end of the second spiral coil portion is connected to an lower end of the first helical coil portion, and an lower end of the third helical coil portion is connected to an outer end of the second spiral coil portion.

2. A wireless power transmission coil, a doughnut-shaped cylindrical space surrounding an central axis of the coil, an surface of the doughnut-shaped cylindrical space being covered with multi-turn winding wires wound around the central axis, an area of the surface of the cylindrical space being divided into an even number of annular regions which have a predetermined width and make one turn around the central axis of the coil,
each annular region being covered with series of the multi-turn winding wires around the central axis, and
wherein a first annular region is covered with an first series of the multi-turn winding wires and a second annular region is covered with a second series of the multi-turn wining wires, and an end of the first series of the multi-turn winding wires and an adjacent end of the second series of the multi-turn winding wires are electrically connected in parallel to a same terminal of the coil, and
wherein the first series of the multi-turn winding wires and the second series of the multi-turn winding wires are wired in parallel in a same direction from the same terminal of the coil,
whereby the series of multi-turn winding wires of each of the annular region are connected in parallel between the terminals of the coil, and the ends of the series of the multi-turn winding wires connecting to a different terminal of the coil are spaced apart by at least the width of the annular region.

3. A wireless power transmission coil according to claim 2, a doughnut-shaped cylindrical space surrounding an central axis of the coil, an surface of the donut-shaped cylindrical space being covered with a series of multi-turn winding wires wound around the central axis of the coil,
an area of the surface of the cylindrical space being divided into a first annular region and a second annular region which have a predetermined width and making one turn around the central axis of the coil,
each annular region being covered with series of the multi-turn winding wires around the central axis,
wherein the first annular region is covered with first series of multi-turn winding wires and the second annular region is covered with second series of multi-turn winding wires, and an end of the first series of the multi-turn winding wires and an adjacent end of the second series of the multi-turn winding wires are electrically connected in parallel to a same terminal of the coil, and
wherein the first series of the multi-turn winding wires and the second series of the multi-turn winding wires are wired in a same direction in parallel from the same terminal of the oil,
whereby the series of multi-turn winding wires of each of the annular region are connected in parallel between the first terminal and the second terminal of the coil, and the end of the series of the multi-turn winding wires connecting the first terminal and the end of the series of the multi-turn winding wires connecting the second terminal are spaced apart by at least the width of the annular region.
